(19) United States
(12) Patent Application Publication
(10) Pub. No.: US 2018/0204273 A1
(43) Pub. Date: Jul. 19, 2018

(54) METHOD OF DATA TRANSMISSION, CORRESPONDING DEVICE AND PROGRAM

(71) Applicant: INGENICO GROUP, Paris (FR)

(72) Inventor: Pierre Quentin, Enghien Les Bains (FR)

(21) Appl. No.: 15/873,341

(22) Filed: Jan. 17, 2018

(30) Foreign Application Priority Data
Jan. 17, 2017 (FR) 1750356

(51) Int. Cl. G06Q 30/06; G06Q 20/32; G06F 17/30

(52) U.S. Cl. CPC G06Q 30/0641; G06F 17/30905; G06F 17/3089; G06Q 20/3278

(57) ABSTRACT

A method of data transmission, implemented by an autonomous electronic device for processing payment transactions, called a payment kiosk. The payment kiosk includes a processor connected to at least one rendering device for rendering offers of items being vended and linked to at least one communications interface and to at least one contactless payment terminal. The method includes: transmission, by a browser installed within the payment kiosk, of a request for obtaining contents made to a contents server; reception, by the browser, coming from the contents server, of an HTML content including at least one exchange tag; processing the HTML content, delivering a view of the HTML content on the at least one rendering device; and preparation, by using the contactless payment terminal, of at least one message transmission as a function of data attributes of the at least one exchange tag.

### 1. FIELD OF THE INVENTION

The present technique relates to the management of non-monitored devices for supplying goods and services. Such devices are also called unattended devices. More particularly, the present invention relates to a method for transmitting messages by means of such devices. More particularly again, a method is presented for transmitting messages addressed to a communications terminal (of a user) as well as a device configured to implement such a method.

### 2. PRIOR ART

There are known devices, the purpose of which is to enable a user to make a purchase of goods and services independently, i.e. without supervision by a merchant. Such devices are also called unattended (i.e. non-monitored) devices. Examples are gas-station pumps and kiosks for issuing cinema tickets. These kiosks, which are classic devices, are small sized and enable payments to be made by using a payment terminal that accepts several forms of payment, namely smartcard payment and magnetic card payment.

More recently, large-sized kiosks have appeared. These are generally multimedia kiosks comprising large screens (generally 46-inch-diagonal screens) which may also be touch screens. Apart from being relatively costly, these kiosks present numerous technical problems. The first is that these multimedia kiosks are proprietary type kiosks. This implies that a multimedia kiosk comprises a set of components (screen, central processing unit, presence sensor, operating system, kiosk management application) that are arranged relative to each other to form the kiosk. Even more recently, multimedia kiosks embedding payment functions have been developed. These multimedia kiosks on the whole comprise the same components as classic multimedia kiosks but additionally embed a payment terminal which is generally contactless.

Such a multimedia kiosk, also called a payment kiosk with reference to the smaller sized kiosks presented here above, uses for example an NFC (Near Field Communication) type of payment terminal. Concretely, to make payment with such a payment kiosk, the user places his NFC-compatible payment means on a very precise place on the kiosk to make payment for what is displayed on the screen. This may be, for example, payment for an item or a service. It may be for example payment for seats at a show or again a donation to an association. In such certain cases, it may be payment for an item or article (which is then delivered to an agreed address).

This type of kiosk is complicated to build and implement. Indeed, as a rule, the products or services on sale that are displayed on the kiosk are more or less pre-programmed. Besides, apart from the fact that such kiosks are relatively impersonal, they also have the disadvantage of not being able to interact intensively with customer users; in particular, although the purchase can be made in a fluid manner by the use of the contactless terminal, the user's “after-sales” experience is often disappointing. For example, when the purchase relates to an article that must be delivered to a given delivery address, it may require the entry, using a touchscreen, of the delivery address and this has to be done by the user himself. Apart from the fact that the requirement of having to enter this address can be complicated for the user, it raises problems of security and confidentiality because, by definition, since the payment kiosk is in a public place, the information entered by the user can be seen by anyone and everyone, and this is not desirable. This example of post-payment entry is representative of the lack of fluidity of the operations to be carried out after purchase. Such situations can also be encountered prior to the purchase and also raise problems.

There is therefore a need to provide a simple, efficient and widely useable solution for simplifying the implementation of such kiosks and for the interaction of these kiosks with the user. More generally, there is a need to facilitate the interaction between an electronic device and a user's communications terminal, especially when there is a programmable electronic device available.

### 3. SUMMARY

The invention does not raise these problems of the prior art. More particularly, the invention provides a simpler solution to the problems and issues identified here above. Indeed, the present technique can be used to provide a solution to the problem of making data exchanges between the vendor and the customer more fluid after the purchase is made.

More specifically, the present technique relates to a method of data transmission, a method implemented by an autonomous electronic device for the processing of payment transactions, called a payment kiosk, said payment kiosk comprising a processor connected to at least one rendering means for rendering offers of items or services being vended and to at least one communications interface and to at least one contactless payment terminal.

Such a method comprises:
step for the transmission, by a browser installed within said payment kiosk, of a request for obtaining contents made to a contents server;
a step for the reception, by said browser, coming from the contents server, of an HTML content comprising at least one exchange tag;
a step for processing said HTML content, delivering a view of said HTML content on said at least one rendering means;
a step for the preparation, by the contactless payment terminal, of at least one message transmission as a function of data attributes of said at least one exchange tag.

Thus the autonomous electronic device for the processing of payment transactions is capable of transmitting messages, contained in the HTML content that it receives from the server, to users and/or customers who have used their communications terminals to receive such a message.

According to one particular characteristic, the request for obtaining content comprises at least one piece of data for identifying a payment kiosk.

Thus, the server is capable of identifying the contents intended for this payment kiosk. The invention thus greatly facilitates the customizing of the content transmitted by the contents server to the autonomous electronic device. Thus, the payment kiosk can, with full discretion, transmit its data in the form of a message to the user. The user's communications terminal receives this data through its contactless interface and carries out the action or actions pertaining to this data. More particularly, the data transmitted by the payment kiosk can for example include a URL to which the communications terminal can link up to carry out a certain number of tasks such as displaying an entry page directly on the user's communications terminal.

According to one particular characteristic, the step for processing said HTML content comprises a step for the determining, within the view to be rendered, of a location of a piece of data representing the exchange tag as a function of a position of a contactless antenna of said at least one payment terminal within said payment kiosk.

According to one particular characteristic, said exchange tag comprises at least one attribute defining a message to be transmitted.

According to one particular characteristic, such attribute for defining the message to be transmitted is a locating address for locating a message in a transaction server, said locating address comprising a parameter for identifying a message and at least one identifier of a payment terminal belonging to said payment kiosk.

According to one particular embodiment, the method comprises a step for cancelling said at least one message transmission, said step for cancelling step being implemented when a duration of display of a message is equal to a determined time parameter and when no transmission has been made during the time period starting after the preparation of the transmission and finishing at the time defined by said time parameter.

According to one particular embodiment, the method comprises the following steps, prior to the step of reception by the browser of the content comprising said at least one exchange tag, at the contents server:
a step for receiving the request coming from the browser;
a step of identification, by means of this request, of said payment kiosk delivering an identifier of said payment kiosk;
a step for the obtaining, within a database, as a function of the identifier of said payment kiosk, of a content to be transmitted to said kiosk, said content comprising at least one message to be transmitted comprising message data;
a step for the obtaining, for each message to be transmitted identified in said content, of a pair of pieces of data comprising an identifier of the payment terminal and an encrypted message to be transmitted;
the creation, by means of the contents server, of an information-locating address to a transaction server comprising the identifier of the payment terminal and the encrypted message to be transmitted;
the creation, using said content and said information-locating addresses, of the HTML content comprising one exchange tag per message to be transmitted.

According to one particular embodiment, prior to the step of reception by the browser of the content comprising said at least one exchange tag, the method comprises the following at the contents server:
a step for receiving the request coming from the browser;
a step of identification, by means of this request, of said payment kiosk delivering an identifier of said payment kiosk;
a step for the obtaining, within a database, as a function of the identifier of the payment kiosk, of a content to be transmitted to said kiosk, said content comprising at least one message to be transmitted comprising message data;
an optional step for the obtaining, for each message to be transmitted in said content, with a transaction server, of a piece of data representing a “challenge” associated with the message to be transmitted;
a step of creation, from said content and said data of the message to be transmitted, of the HTML content comprising an exchange tag for the message to be transmitted, comprising the optional challenge.

The invention also relates to an autonomous electronic device for the processing of payment transactions, called a payment kiosk, said payment kiosk comprising a processing server connected to at least one rendering means for rendering offers of items or services being vended and linked to at least one communications interface and to at least one contactless payment terminal. Such a device comprises:
means of transmission of a request for obtaining content to a contents server, implemented by a browser installed within said payment kiosk;
means of reception of an HTML content comprising at least one exchange tag, addressed to the browser and coming from the contents server;
means for processing said HTML content, delivering a view of said HTML content on said at least one rendering means;
means of preparation, by the contactless payment terminal, of at least one message transmission as a function of data attributes of said at least one exchange tag.

According to a preferred implementation, the different steps of the methods of the invention are implemented by one or more software programs or computer program comprising software instructions to be executed by a data processor of a relay module according to the invention and designed to command the execution of different steps of the methods.

The invention is therefore also aimed at providing a program, capable of being executed by a computer or by a data processor, this program comprising instructions to command the execution of the steps of a method as mentioned here above.

This program can use any programming language whatsoever and be in the form of source code, object code or intermediate code between source code and object code such as in a partially compiled form or in any other desirable form whatsoever.

The invention is also aimed at providing an information carrier readable by a data processor and comprising instructions of a program as mentioned here above.

The information carrier can be any entity or communications terminal whatsoever capable of storing the program. For example, the carrier can comprise a storage means such as a ROM, for example, a CD ROM or microelectronic circuit ROM or again a magnetic recording means, for example a floppy disk or a hard disk drive.

Furthermore, the information carrier can be a transmissible carrier such as an electrical or optical signal that can be conveyed via an electrical or optical cable, by radio or by other means. The program according to the proposed technique can especially be uploaded to an Internet type network.

As an alternative, the information carrier can be an integrated circuit into which the program is incorporated, the circuit being adapted to executing or to being used in the execution of the method in question.

According to one embodiment, the proposed technique is implemented by means of software and/or hardware components. In this respect, the term “module” can correspond in this document equally well to a software component and to a hardware component or to a set of hardware and software components.

A software component corresponds to one or more software module programs, one or more sub-programs of a program or more generally to any element of a program or a piece of software capable of implementing a function or a set of functions according to what is described here below for the module concerned. Such a software component is executed by a data processor of a physical entity (terminal, server, gateway, router etc) and is capable of accessing hardware resources of this physical entity (memories, recording media, communications buses, input/output electronic boards, user interfaces etc.).

In the same way, a hardware component corresponds to any element of a hardware assembly capable of implementing a function or a set of functions according to what is described here below for the module concerned. It can be a programmable hardware component or a component with an integrated processor for the execution of software, for example, an integrated circuit, a smart card, a memory card, an electronic board for the execution of firmware etc.

Each component of the system described here above implements of course its own software modules.

The different embodiments mentioned here above can be combined with one another to implement the invention.

### 4. FIGURES

Other features and advantages of the invention shall appear more clearly from the following description of a preferred embodiment, given by way of a simple illustratory and non-exhaustive example and from the appended drawings, of which:

FIGS. 1A and 1B present a payment kiosk that is the object of the present invention;

FIG. 2 presents a more detailed view of the components of such a payment kiosk;

FIG. 3 presents a general view of the obtaining of data to be transmitted by the browser integrated into a payment kiosk that is the object of the present invention;

FIG. 4 describes the implementing of an exchange tag in a specific embodiment;

FIG. 5 describes the implementing of an exchange tag in another embodiment.

### 5. DESCRIPTION

### 5.1. General Description

As explained here above, the technique generally proposes the replacement of the “proprietary” application for implementing the payment kiosk. The application in question is replaced by a browser. This replacement makes it possible to have only a limited number of types of payment kiosk management applications. Essentially, assuming that a payment kiosk can implement a Windows' or a Linux™ system, only two browser versions are needed, one for the Windows' environment and one for the Linux™ environment.

Another advantage is that it leaves the server with the responsibility for displaying offers on the kiosk. Indeed, since the “classic” management application is replaced by a browser, the browser limits itself to displaying data transmitted to it in to a format that is also transmitted to it. Thus, according to the present invention the browser receives an HTML type document from the server to which it attaches one or m*ore style-sheets and one or more Javascript code libraries. The adjoining of this data can be achieved by inserting a link to the resources or directly by inserting data into the “HTML” type document.

However, although such an implementation is promising from the technical and economic viewpoint, it cannot resolve all the problems posed. Beyond the problems related to the management of the platform there is also the management of post-payment or pre-payment made through the kiosk. It may be recalled indeed that the kiosk is capable of making payments through one or more payment terminals directly integrated into the kiosk. The use of a “proprietary” application in a “controlled” environment has the advantage of equally controlled management of the payment terminal. The replacement of this “proprietary” application by a browser brings up problems to be resolved, especially the problem of control over payment terminals and that of way in which pre-payment or post-payment is transmitted to the user (the customer).

To resolve this problem, the present technique implements a novel tag, called an exchange tag. This tag, which is known to the browser, comprises data on the pre-payment or post-payment processing to be done by the kiosk. The working of this tag is described in detail here below. When the kiosk browser receives the HTML type document (coming from the server), it displays this document on the kiosk screen embellished with styles from the style sheets and comprising javascript type code. At least one exchange tag is present within this document. This is an exchange tag that the browser interprets in order to carry out the actions required by this tag, in connection with the payment terminal or terminals of the kiosk, with the goal of transmitting data for example subsequently to the payment itself (the payment being managed, besides, by means of a payment tag). The transmission of messages subsequently to the payment is not obligatory. The data can also be transmitted prior to the payment, depending on the requirement of interaction with the user. In other words, the data-exchanging tag is used for the transmission to the user of data that can be used to foster interaction between the user and the merchant (i.e. the one selling the product or the service proposed at the kiosk). In particular, the exchange tag modifies the mode of communication between the merchant and the user (the customer). If we take up the example of data entry, which the user had to carry out on the big screen of the payment kiosk, the use of the data-exchange tag enables the transmission, to the user's communications terminal, of a message (comprising for example a URL generated by the merchant), that is processed by the communications terminal that receives it and that, for example, links up to a server dedicated to data entry by using this communications terminal. This is is far more discreet, secured and does not oblige the user to remain before the kiosk to make this entry.

Other messages can also be transmitted, such as digital cash receipts, digital purchase vouchers, data enabling the execution of a specific application installed on the user's communications terminal, proof of purchase and promotions. A promotion can for example consist of pieces of data representing a reduction on a product to be purchased (and therefore transmitted before purchase). This is also the case when launching a specific application which can be carried out before the purchase (and the payment) made on the kiosk. Examples are described in detail here below.

Be that as it may, according to the invention, the message containing the data is transmitted by the payment kiosk to the user's communications terminal by means of an NFC interface which is present within the payment kiosk. As explained here below, the use of this NFC interface for transmitting data to the payment terminal has many advantages.

Besides, the invention has a major effect related to the merchant's capacity (i.e. the merchant whose products are displayed on the kiosk) to interact with the customer (the one who purchases the product) through the payment kiosk, which is itself operated by a payment kiosk operator (for example a transport authority or the like).

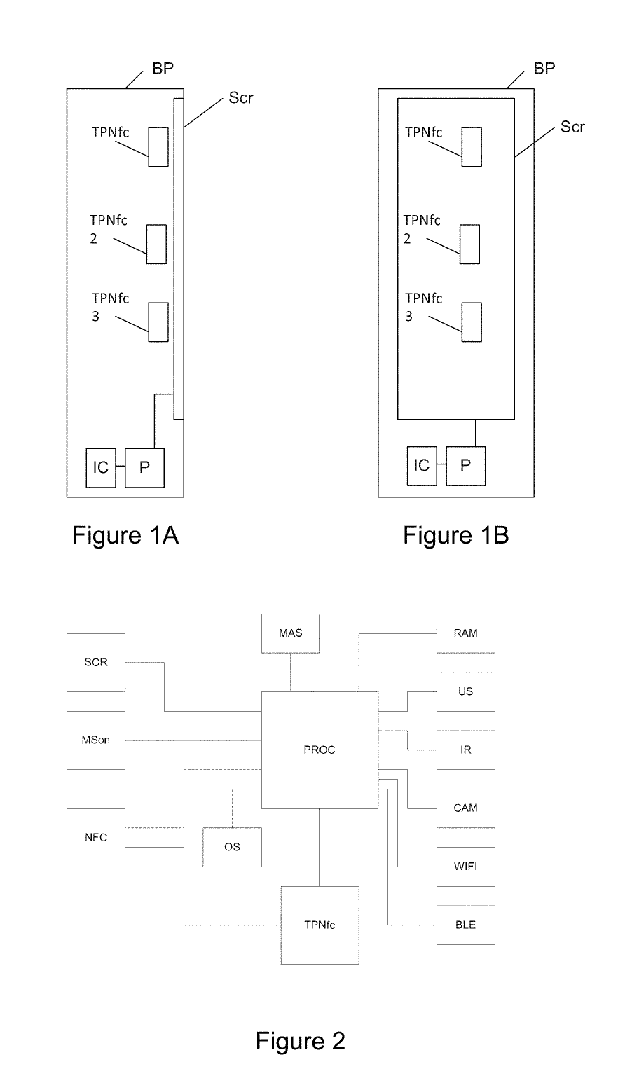

Referring to FIGS. 1A and 1B, a payment kiosk according to the present invention is described. Such a payment kiosk takes the form of a housing comprising an information-rendering means such as a screen and/or a speaker. The information-rendering means is connected by one more data buses to a processor. This processor can be any type of processor usually intended for such tasks such as PC type processors or processors intended for more compact terminals such as SOC (System on Chip) devices. The processor comprises a bus for access to a random-access memory, a bus for access to a mass storage memory, a bus for access one or more network communications interfaces (Wi-Fi, Bluetooth, RJ45 type interface networks) and one or more buses (USB or Universal Serial Buses) for access to serial type communications interfaces. In addition, the processor comprises an access bus for access to at least one communications terminal taking the form of a contactless type payment terminal. Such a contactless payment terminal comprises a secured processor, a secured memory, and bus for access to an NFC processor, an NFC antenna connected to the NFC processor. The payment terminal can also comprise one or more dedicated communications interfaces. Depending on the embodiments, the communications interfaces of the payment terminal can be shared with the communications interfaces of the processor. The processor and the different modules that form the payment kiosk are run by an operating system. The operating system is of a standard type and can be based on a derivative version of the Linux™ system. It comprises modules for managing the different components of the kiosk with the exception of the payment terminal or terminals. The operating system for its part brings about the operation of a browser adapted to implement the present invention and especially adapted to the management and operation of exchange tags. A payment terminal for its part is also run by a proprietary type of system of operating system (this does not change relative to prior art kiosks). However, the data transmitted to the payment terminal and received from the payment terminal are appreciably different from those of the prior art as shall be explained here below.

Referring to FIG. 2, we present the architecture of a payment kiosk according to the present technique. Such a payment kiosk (BP) comprises a screen (Scr) preferably a touch screen. Such a screen is of a size sufficient for the display of one or more advertisement messages such that they are visible to passersby. Thus, the screen typically has a size ranging from 32-inch diagonal to 55-inch diagonal. A typical advertisement message displayed by such a screen comprises for example a video and/or photographs and/or text.

Depending on the intended environment of the payment kiosk (BM), this kiosk must also include a sound-rendering module (MSon): the sound-rendering module is intended for the production of sounds that may accompany the advertisement messages issued, when such sounds can be perceived by the users.

The screen (Scr) and the sound-rendering module (if it is present) are connected by one or more data-transport buses to a processor (Proc). Such a processor (Proc) has sufficient processing capacity to carry out various multimedia processing tasks such as for example the display of high-quality video and/or the display of higher-resolution images. The processor (Proc) is furthermore capable of receiving data by means of data transportation buses connecting the processor (Proc) to the NFC module (if it is not directly managed by the integrated payment terminals) or again to the wireless communications modules (such as for example the Wi-Fi module or the Bluetooth BLE module).

The processor (Proc) is furthermore connected optionally by means of a data bus to sensors (ultrasound (US) sensors, infrared (IR) sensors or again a camera (CAM)) to receive signals sent by these sensors in order to detect, as the case may be, the presence of one or more users. These signals are converted by the processor and given to the operating system (OS). The processor also has a random-access memory (RAM) and a mass storage memory (MAS).

The operating system takes sees to the execution of the browser and the managing of the data exchanges between the different components and the browser. In other embodiments, the payment kiosk can take the form of a computer, tablet or smartphone type of terminal that embeds components identical or similar in their functions and capable of implementing the methods described herein, in which case the term ‘payment kiosk’ will be replaced by a more suitable expression.

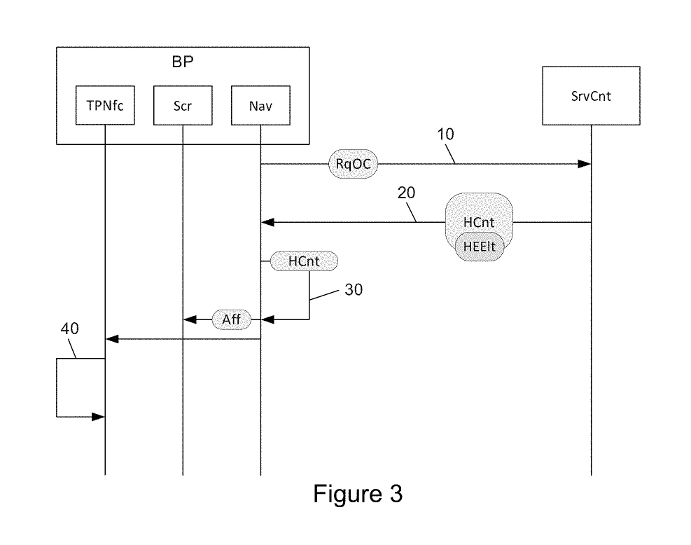

Referring to FIG. 3, we describe the general operation of a payment kiosk in carrying out an operation for processing a transmission of a message by means of an exchange tag representing the message to be transmitted. In a first stage, the payment kiosk must receive, from the server, data to be displayed and information on messages to be transmitted. The method implemented on this occasion is the following:
a step of transmission (10) to the contents server (SrvCnt) of a request for obtaining content (RqOC), said request for obtaining content comprising at least one piece of identification data (iBP) for identifying the payment kiosk;
   this request is implemented from the kiosk; it is therefore the kiosk that is the party requesting the data to be displayed, and this is done to enable an accurate implementation of the data exchange as explained here below;
a step for receiving (20) at least one HTML content (HCnt) to be displayed, coming from the contents server (SrvCnt), said content comprising at least one exchange tag (HPElt);
a step for processing (30) said HTML content (HCnt) delivering a view (Aff) of said HTML content (HCnt) on said at least one rendering means (Scr) comprising especially the display of said content by said browser, data representing the exchange tag (the indication by which the user can bring his communications terminal closer to receive the message transmitted by the kiosk) being displayed in proximity to the NFC antenna of a payment terminal of the payment kiosk. This is implemented for example by the determining, within the view to be rendered, of a location of a piece of data representing the exchange tag, according to a position of a contactless antenna of said at least one payment terminal within said payment terminal.

In a complementary way, the content of the HTML type document also comprises a piece of data representing a time of display of the content. When this time of display has elapsed, the above method is again executed in order to display a new content on the screen. The object of this last step is twofold: it makes it possible not to allow the permanent display of “static” content which would have the consequence, on the one hand, of reducing the service life of the display device and, on the other hand, of having a relatively disappointing effect (due essentially to the fact that a fixed display does not attract attention and therefore does not highlight the value of the goods and services on offer as displayed on the kiosk).

In a second stage, subsequently to or at the same time as the display of the content on the screen, the payment terminal prepares (40), in advance (by anticipation), the message or messages to be transmitted. The number of message transmissions depends firstly on the number of payment terminals installed in the kiosk and secondly on the number of tags present in the content. For example, if there are four payment terminals and only three tags, only three message transmissions are prepared. Conversely, if three payment terminals are installed in the kiosk and four message-transmission tags are present, only three message transmissions are prepared (and sorted in order of appearance or location of the payment terminal).

The preparation of a transmission of messages is also conditional: either this preparation is done independently of a payment and is therefore carried out in advance, i.e. before a user has revealed his intention to purchase an article or a service (independently of the preparation of a payment transaction), or the transmission of data is conditional on a purchase (and is therefore done subsequently to the payment transaction). In the latter case, either the data exchange tag is conditional, and the data transmission is not necessarily prepared in advance (it can be prepared in advanced but the transmission in itself takes place only after the validation of the payment transaction) or the data exchange tag is received after payment, during an updating of the HTML content, in which case the method implemented is independent and all that it requires, from the server which transmits the tag, is a confirmation of payment for the article or service.

The preparation of a transmission of messages (in advance, i.e. before a user has revealed his intention to purchase an item or a service) has two purposes: firstly not having to detect the presence of the user (to initiate the transmission) and secondly, enabling immediate transmission of the message.

The preparation of a transmission of messages intended for a communications terminal is essentially done through the exchange tag (or tags) contained in the HTML document.

An exchange tag according to the present invention is essentially an instruction intended for the browser enabling the browser to prepare the transmission of a message and to do so whatever the nature of this message because the message to be transmitted is recorded as an attribute of the tag. An exchange tag is so to speak a universal interface between the server that transmits the content and the payment terminal. The exchange tag is implemented in conjunction with the browser. The exchange tag on the whole takes the following form and represents the message to be transmitted to a communications terminal:

<dataexchange></dataexchange>

The exchange tag comprises a plurality of attributes, including the usual attributes of identification (“id”, “name”, “image”) and styles enabling the display of a content of the tag when necessary. The exchange tag also has specific attributes used to prepare the transmission of the message to the communications terminal. Essentially two methods, either mutually exclusive or complementing each other depending on the implementation, are used to prepare the transaction.

The following are the possible attributes of the tag:
link: specifies an address of location of the message to be transmitted; this is an attribute used to obtain the message to be transmitted from a location different to that of the content (for example directly with a merchant, this merchant being not necessarily the operator the payment kiosk);
record: specifies the message to be transmitted, for example in the form of a NDEF recording;
type: specifies the type of message to be transmitted;
merchant: specifies parameters of the merchant (the operator of the payment kiosk);
   the merchant's parameters can be (and most often are) encrypted: it is up to the payment terminal to decrypt these pieces of information using data of which it has knowledge;
challenge: specifies a challenge: the challenge comes for example from a remote server, different from the contents server, and enables the payment terminal to make a mutual authentication when the transmission of the data is being prepared.

Should the message (for example an NDEF recording) be transmitted after a payment transaction, the data of the HTML content are displayed and the payment terminals of the kiosk prepare the transactions (by anticipation), in order to enable the users to make payment by placing their NFC communications terminals at positions the indicated by the payment tag, of which at least certain data elements (for example the price and/or a contactless payment logo) are displayed on the screen.

Two events can occur following the preparation of the transaction: either the payment is carried out by a user for one of the offers displayed (and the message is transmitted at the end of the transaction to the user's communications terminal) or no payment is made (within a given period of time). In this case, the method comprises a step for cancelling payment transactions initiated in advance, the cancellation being implemented when a duration of display of the offer is greater than or equal to a determined time parameter and when no payment has been made during the time period starting at the end of the preparation of the transaction and ending at the time defined by said time parameter. If this cancellation occurs, the method previously described (steps 10 to 40) is again implemented, leading to the display of “new” information and the preparation of new payment transactions and new messages to be transmitted by anticipation.

Should the data be transmitted independently of the performance of a transaction, the data of the HTML content is displayed and the payment terminals of the kiosk prepare the transmission of the messages contained in the data exchange tags.

### 5.2. Implementing an Exchange Tag

There are mainly two methods for implementing this exchange tag: one uses the link attribute and the other uses the descriptive attributes. The distinction between the implementing of the first method and that of the second method can take account of the physical parameters of the payment kiosk but also of the parameters related to the messages to be transmitted or again parameters proper to the managing operator of the payment kiosks (who manages a set of payment kiosks). Thus, the implementing of either of these two methods is often pre-defined. Implementing the exchange tag enables the payment terminal to transmit messages associated with the offers present in the content and/or with the purchases made by the user.

### 5.2.1 First Method of Implementation

In a first method, the payment terminal is provided with messages to be transmitted by means of an URL. In this case, the tag uses the “link” attribute which, if it has a value attached to it, comprises a link (a URL) towards a secured resource comprising the message to be transmitted. This URL can be an address towards either the contents server (the one that delivers the HTML content to be displayed) or a third-party server (a server of a merchant who is vending the item, different from the operator of the payment kiosk).

This URL enables for example the kiosk browser (depending on the cryptographic hardware that it embeds) to know the messages to be transmitted and configure the payment terminal to prepare the transmission of these messages by means of its NFC interface. However, more efficiently, this URL directly enables the selected payment terminal to know the messages to be transmitted and to configure itself accordingly and get authenticated with a server accordingly: the utility of this is that it makes sure that the messages transmitted are not compromised by an undesired modification of the browser.

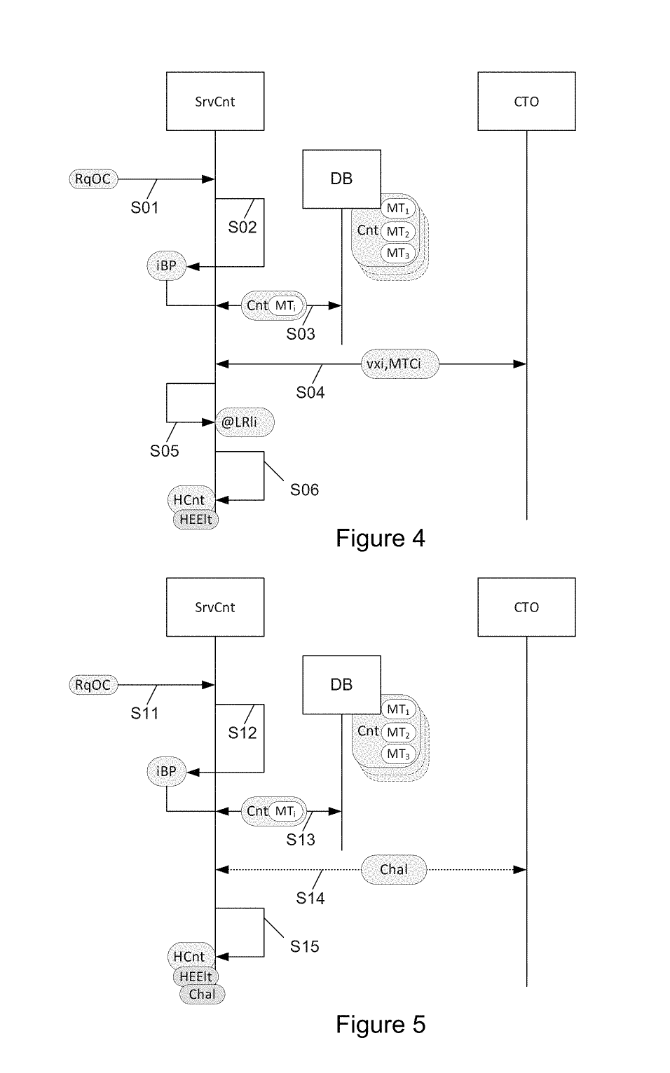

Thus, to implement such a method, using the <link> tag according to the present invention, in at least one embodiment, described with reference to FIG. 4, when the browser (Nav) transmits a request for obtaining content to the contents server (SrvCnt), the following method is implemented by the contents server (SrvCnt):
receiving (S01) the request (RqOC) coming from the browser (Nav);
identifying (S02), by means of this request, said payment kiosk (BP) delivering an identifier (iBP) of said payment kiosk;
obtaining (S03), within a database (BD), as a function of the identifier (iBP) of the payment kiosk (BP), a content (Cnt) to be transmitted to said kiosk (BP), said content comprising at least one message to be transmitted (MTi) comprising parameters (data, type of data, a date, a duration and parameters of the merchant);
obtaining (S04) a pair of pieces of data for each message to be transmitted (MTi) identified in said content, the pair of pieces of data comprising a payment terminal identifier (vxi) and an encrypted message to be transmitted (MTCi), this obtaining step comprising:
   the transmission of the message to be transmitted (MTi) to a transaction server (CTO);
   the determining, among the payment terminals ((vx1, . . . vx6), of the payment kiosk, of an identifier of the payment terminal (vxi) associated with this message to be transmitted (MTi);
   the creation, from the parameters of the message to be transmitted (MTi) and/or other parameters, of an encrypted message to be transmitted (MTCi);
      this piece of data is encrypted by means of the public key of the payment terminal in charge (vxi);
      when the payment terminal obtains knowledge of this piece of data, it can authenticate it as being generated by the transaction server (see here below);
      the attribute “challenge” can also be generated by the transaction server at this time (to enable the payment terminal to take up the challenge generated by the transaction server before the transmission of the data);
   the transmission by the transaction server (CTO) to the contents server (SrvCnt) of the pair formed by the identifier of the payment terminal (vxi) and the encrypted message to be transmitted (MTCi);
the creation (S05), by the contents server (SrvCnt), of an information-locating address (@LRIi) towards the transaction server (CTO), comprising the identifier of the payment terminal (vxi) and the encrypted message to be transmitted (DCOi);
the creation (S06), on the basis of said content (Cnt) and information-locating addresses (@LRIi), of the HTML content (HCnt) comprising one exchange tag (HEElt) per message to be transmitted (MTi).

This embodiment has the advantage of not requiring the supply of “secret” data to the browser. Indeed, with this method, the browser does not know which are the messages to be exchanged with the communications terminal. These messages are encrypted and transmitted directly by the browser (and the corresponding API) to the payment terminal, the identifier of which is present in the URL. Thus, even if the browser is compromised (i.e. if it is being monitored in order to impair its operation or to degrade the payment operations), it is not possible to modify the data contained in the messages to be exchanged with the communications terminal, these being messages that are encrypted and that can be decrypted only by the payment terminal (vxi) designated for this piece of data to be exchanged. However, this embodiment has the drawback of making it necessary for the browser to obtain data of the message to be transmitted from the payment terminal and of therefore requiring additional exchanges between the payment terminal and the browser (exchanges that are of course secured). Thus, this embodiment is more efficient in terms of security but entails greater constraints in terms of implementation.

Advantageously, when the message is transmitted following the effective implementation of a transaction by the transaction server (CTO), the server of the merchant from whom the item or service has been purchased is capable, having knowledge of a transaction identifier (and/or an order number), of linking the transaction to the type of message to be transmitted to the customer user, for example in order to enable complementary entry and/or provide proof of purchase etc. This is also valid for the second embodiment described here below.

### 5.2.2. Second Method of Implementation

A second method of implementing the exchange tag consists in providing the payment terminal with data for transmitting messages by means of the attributes of the exchange tag. In this case, the link attribute is not necessarily used. Besides, the obtaining of data from the contents server (SrvCnt) is different from that of the previous method.

To implement such a method, using exchange tags, according to the present invention in at least one embodiment described with reference to FIG. 5, when the browser (Nav) transmits a request for obtaining content to the contents server (SrvCnt), the following method is implemented by the contents server (SrvCnt);
receiving (S11) the request (RqOC) coming from the browser (Nav);
identifying (S12), through this request, said payment kiosk (BP), delivering an identifier (iBP) of said payment kiosk;
obtaining (S13), within a database, (BD) and as a function of the identifier (iBP) of the payment kiosk (BP), a content (Cnt) to be transmitted to said kiosk (BP), said content comprising at least one message to be transmitted (MTi) comprising parameters (recording, type of recording, a date, a duration and parameters of the merchant);
obtaining (S14), optionally for each message to be transmitted (MTi) identified in said content, from a transaction server (CTO), of a “challenge” (Chal) associated with the message to be transmitted (MTI) comprising:
   the transmission of the message to be transmitted (MTi) to the transaction server (CTO);
   the creation, using parameters of the message to be transmitted and/or other parameters, of a piece of encrypted challenge data (Chal);
   the transmission, by the transaction server (CTO), of said piece of encrypted challenge data (Chal);
creating (S15), from said content (Cnt) and data of the message to be transmitted, the HTML content (HCnt) comprising an exchange tag (HEElt) for the message to be transmitted (MTi) comprising the optional challenge (Chal).

This embodiment has the advantage of enabling the browser to directly integrate the messages to be transmitted into the view without requiring any decoding. This implementation is less secure than the first one but also more flexible. Indeed, the browser directly obtains knowledge of the data of the messages to be transmitted without having to call upon the payment terminal and can therefore prepare the view more speedily. The payment terminal also receives the messages intended for it (the recording) from the browser. Using the data received, the terminal sends a request to the transaction server and a series of exchanges takes place in order to enable the authentication of the terminal, the transaction server, data to be transmitted. The method implemented comprises the following steps:
a step for the reception, by the payment terminal, of the parameters of the message to be transmitted: they are transmitted by the browser by means of an API;
a step for obtaining a piece of data representing the transaction server; it can either be stored in a protected memory of the payment terminal or be provided by the browser;
a step for the creation, using data of the message to be transmitted and a private key of the payment terminal, of a piece of encrypted data representing the message to be transmitted: the payment terminal encrypts the data with its private key and possibly with the public key of the transaction server; thus, only the transaction server having both the public key of the terminal and its private key can decrypt the data transmitted by the payment terminal;
a step for transmitting a processing request to said transaction server, said processing request comprising the piece of encrypted data representing the message to be transmitted and an identifier of the terminal; and
when the transaction server accepts the data transmitted by the payment terminal, a step for the reception, from the transaction server, of a piece of data representing an acceptance of processing of this data by the payment terminal.

Thus, only an authentic payment terminal and an authentic transaction server are capable of preparing the transmission of messages that are equally authentic. It can be noted that the use of the exchange tag advantageously makes it possible to “pass” data to the payment terminal transparently for the contents server. This makes it possible to have far simpler management of the contents to be transmitted to the payment kiosk: it is no longer necessary to have a “proprietary” content and standardized contents can be used without its having any impact on the security of all the data transmissions carried out by the payment kiosk.

### 5.3. Implementing a Transmission of Messages by Anticipation (Before a Payment)

The first method for preparing transmissions of messages comprises, as explained here above, the use of an address in the “link” tag. This embodiment is implemented rather when the payment terminal has its own communications resources for communications towards the payment and/or merchant servers, for example its own network interface, but this is in no way obligatory. In this embodiment, the payment terminal retrieves the data to be transmitted from a URL of the tag, this URL (a secured URL of the https://type) being transmitted by the browser. The payment terminal transmits a request to the server which identifies it (for example through the user agent or another parameter added by the terminal to the URL) and verifies (or even provides) the data to be transmitted.

Using this information, the terminal prepares the transmission, i.e. it initiates the transmission and then waits for the presentation of a communications terminal. In other words, the terminal acts as if the merchant had already identified a user to which this data would be transmitted. The difference is that, in principle, neither the merchant nor the terminal has any information whatsoever on the presence or non-presence of a user. The transmission of the message therefore remains “open” for a pre-determined period of time. As explained, if a customer presents his communications terminal before the contactless antenna of the payment terminal, the transmission of a message is validated by the payment terminal of the kiosk. The advantage of this procedure is that the message is transmitted rapidly, that there is no need to detect the presence of the user (the client) since it is he who reveals his presence by presenting his contactless communications terminal before the terminal. Thus, this tag and this manner of transmission resolve one of the problems explained here above with the prior-art payment kiosks, namely the need to detect the presence of the user with presence sensors.

In the second transmission-preparing method, the browser configures the payment terminal so that it can prepare the transmission. This embodiment is implemented rather when the payment terminal does not have its own communications resources and when the operating system of the kiosk acts as a gateway towards the servers (payment and/or merchant servers) but this is in no way obligatory. In this embodiment, the browser retrieves the data on the exchange tag (record, type, merchant's parameters, date, challenge) and forwards this information to the payment terminal by means of an API of the payment terminal, this API being used by the operating system to exchange information with the payment terminal. Otherwise, the method of initializing the transmission is the same as here above and the advantages obtained are identical.

### 5.4. Progress of the Transmission

When the transmission has been prepared, its finalizing is simple. It is enough, to this end, for the user to place his communications terminal at the place indicated so that the payment terminal can transmit the recording (“record” data of the exchange tag, for example an NDEF recording). To this end, just after the initialization of transmission, the payment terminal sends out a transmission request. The sending of this request is done cyclically, for as long as the display of the indication of transmission lasts on the screen. When the user places his communications terminal at the place indicated, the recording is immediately obtained by the communications terminal, which carries out the operations required by the recording (depending on the type and on the data contained in the NDEF recording).

1. A method of data transmission, the method being implemented by an autonomous electronic device for processing payment transactions, called a payment kiosk, said payment kiosk comprising a processor connected to at least one rendering device for rendering offers of items or services being vended and linked to at least one communications interface and to at least one contactless payment terminal, said method comprising the following acts:
transmission, by a browser installed within said payment kiosk, of a request for obtaining contents made to a contents server;
reception, by said browser, coming from the contents server, of an HTML content comprising at least one exchange tag;
processing said HTML content, delivering a view of said HTML content on said at least one rendering device;
preparation, by the contactless payment terminal, of at least one message transmission as a function of data attributes of said at least one exchange tag.

2. The method according to claim 1, wherein the request for obtaining content comprises at least one piece of data for identifying a payment kiosk.

3. The method according to claim 1, wherein the act of processing said HTML content comprises determining, within the view to be rendered, of a location of a piece of data representing the exchange tag as a function of a position of a contactless antenna of said at least one payment terminal within said payment kiosk.

4. The method according to claim 1, wherein said exchange tag comprises at least one attribute defining a message to be transmitted.

5. The method according to claim 4, wherein said attribute defining the message to be transmitted is a locating address for locating a message in a transaction server, said locating address comprising a parameter for identifying a message and at least one identifier of a payment terminal belonging to said payment kiosk.

6. The method according to claim 1, further comprising cancelling said at least one message transmission, said cancelling being implemented when a duration of display of a message is equal to a determined time parameter and when no transmission has been made during the period of time starting at the end of the preparation of the transmission and finishing at the time defined by said time parameter.

7. The method according to claim 1, further comprising, prior to the act of reception by the browser, of the content comprising said at least one exchange tag, at the contents server:
receiving the request coming from the browser;
identification, by using this request, of said payment kiosk delivering an identifier of said payment kiosk;
obtaining, within a database, as a function of the identifier, of a content to be transmitted to said kiosk, said content comprising at least one message to be transmitted comprising message data;
obtaining, for each message to be transmitted identified in said content, a pair of pieces of data comprising a payment terminal identifier and an encrypted message to be transmitted;
creation, by using the contents server, of an information-locating address to a transaction server comprising the identifier of the payment terminal and the encrypted message to be transmitted;
creation, using said content and information-locating address, of the HTML content comprising one exchange tag per message to be transmitted.

8. The method according to claim 1, further comprising, prior to the act of reception by the browser of the content comprising said at least one exchange tag, at the contents server:
receiving the request coming from the browser;
identification, by using this request, of said payment kiosk delivering an identifier of said payment kiosk;
obtaining, within a database, as a function of the identifier of the payment terminal, a content to be transmitted to said kiosk, said content comprising at least one message to be transmitted comprising message data,
creation, from said content and data of the message to be transmitted, of the HTML content comprising an exchange tag for the message to be transmitted.

9. An autonomous electronic device for processing payment transactions, called a payment kiosk, said payment kiosk comprising:
at least one rendering device;
at least one communications interface;
at least one contactless payment terminal;
a processor connected to the at least one rendering device for rendering offers of items or services being vended and linked to the at least one communications interface and to the at least one contactless payment terminal; and
a non-transitory computer-readable medium comprising instructions stored thereon, which when executed by the processor configure the payment kiosk to perform acts comprising:
transmission of a request for obtaining content to a contents server, implemented by a browser installed within said payment kiosk;
reception of an HTML content comprising at least one exchange tag, addressed to the browser and coming from the contents server;
processing said HTML content, delivering a view of said HTML content on said at least one rendering device;
preparation, by the contactless payment terminal, of at least one message transmission as a function of data attributes of said at least one exchange tag.

10. A non-transitory computer-readable medium comprising a computer program product stored thereon, which comprises program code instructions for execution of a method of transmission, when the instructions are executed by a processor of an autonomous electronic device, called a payment kiosk, wherein the method comprises:
rendering on at least one rendering device offers of items or services being vended and linked;
transmission, by a browser installed within said payment kiosk, of a request for obtaining contents made to a contents server;
reception, by said browser, coming from the contents server, of an HTML content comprising at least one exchange tag;
processing said HTML content, delivering a view of said HTML content on said at least one rendering device;
preparation, by the contactless payment terminal, of at least one message transmission as a function of data attributes of said at least one exchange tag.

11. The method according to claim 8, wherein the HTML content further comprises a piece of data representing a “challenge” associated with the message to be transmitted, said piece of data representing the “challenge” being obtained with a transaction server, after obtaining the content to be transmitted to the kiosk.
